(19) United States
(12) Patent Application Publication
(10) Pub. No.: US 2005/0068793 A1
(43) Pub. Date: Mar. 31, 2005

(54) Pulse width modulated power supply

(76) Inventors: Dorian Davies, Bishops Stortford (GB); Graham Dolman, Saffron Walden (GB); Philip Holder, Bishops Stortford (GB)

Correspondence Address: BARNES & THORNBURG, P.O. BOX 2786, CHICAGO, IL, 60690-2786, US

(21) Appl. No.: 10/675,771

(22) Filed: Sep. 30, 2003

(51) Int. Cl. H02M 1/12

(52) U.S. Cl. 363/41

(57) ABSTRACT

A pulse width modulated (PWM) power supply has a plurality of phases. Each phase comprises a power switching device for generating an output signal. A controller receives a modulating input signal and generates a set of control signals, each control signal controlling the operation of the switching device in a respective one of the phases. Each control signal comprises a sequence of time windows, with a pulse of variable width positioned within each time window. Control signals for some of the phases are aligned to different parts of their respective time windows compared to the control signals for other phases. This has been found to improve linearity when operating at extremes of normal operating range.

### FIELD OF THE INVENTION

This invention relates to pulse width modulated (PWM) power supplies.

### BACKGROUND TO THE INVENTION

Pulse Width Modulated (PWM) power supplies are widely used in a variety of applications. A power switching device, such as a power transistor, is turned on and off at a high frequency, with the width of the ‘on’ periods varying in sympathy with the amplitude of a modulating input signal. The resulting train of output pulses from the switching device is smoothed by a low pass filter to deliver a supply voltage which varies in sympathy with the modulating input signal. Referring to FIG. 1, this shows an output PWM signal 20 comprising a series of variable width pulses 21, 22, 23, 24. Each pulse is positioned within a time window 10 of fixed width. In the output signal 20, each of the pulses 21, 22, 23, 24 are each substantially aligned with the left-hand edge of window 10. As pulses increase in width, they progressively ‘grow’ from the left-hand end (beginning) of the window. In other systems it is known to align the pulses in the output signal with the centre of the window. Referring to the lower half of FIG. 1, this shows an output PWM signal 30. The variable width pulses 31, 32, 33, 34 in the output signal 30 are each aligned centrally within the centre of window 10. As pulses increase in width, they progressively ‘grow’ from the centre-most point 11 of the window 10.

A PWM power supply can have a single phase or multiple phases, with the contributions of individual phases summing to provide an overall output. Multi-phase PWM power supplies have an advantage over single phase PWM supplies in that they can deliver better resolution and increased current. It should be noted that the term ‘phase’ relates to apparatus which receives an input signal and operates a switching device rather than a phase in an electrical sense. In multi-phase PWM power supplies the time window within which the pulses of each phase are positioned is offset from the windows of other phases. FIG. 2 shows an example multi-phase system with four phases (data phase 1, . . . , data phase 4). Input data, representing the samples of an input signal, are received in regular bursts, here numbered 1 to 8. The data value in burst 1 is coded into a pulse for phase 1, which occupies the time window numbered 1. The data value in burst 2 is coded into a pulse for phase 2, which occupies the time window numbered 2, and so on. The data value in burst 5 is coded into the next pulse for phase 1, which occupies the time window numbered 5. As shown in the lower part of FIG. 2, the variable width pulses of each phase take the same position in their respective time windows, each being aligned with the left-hand edge (beginning).

It is also known to use a PWM power supply in combination with a power amplifier in order to improve the efficiency of the amplifier. The power supply to the amplifier is modulated by the envelope of the signal which is to be amplified. Switching devices have a finite frequency range over which they can be reliably operated, and begin to work in a non-ideal manner when operated towards the extremes of their operating range. The sampling frequency and frequency at which the switching devices in the power supply operate must be greater than the highest frequency in the input signal, to avoid aliasing distortion effects. When a PWM power supply is used to modulate a power amplifier, in the manner just described, with an input signal having a wide bandwidth, the switching device is forced to operate at a frequency which is near the upper boundary of its operating range. This incurs switching losses and begins to cause non-ideal behaviour. As an example, the base stations in a third generation, two channel Universal Mobile Telecommunications System (UMTS) are expected to transmit and receive signals having a bandwidth of around 10 MHz, which requires switching devices in the PWM power supply to operate at rates well in excess of this. These switching rates are at the upper limits of present power switching technology.

Accordingly, the present invention seeks to provide a power supply which can operate in a more linear manner over its operating range.

### SUMMARY OF THE INVENTION

A first aspect of the present invention provides a multi-phase pulse width modulated power supply comprising:
an input for receiving a modulating input signal;
a plurality of phases, each phase comprising a power switching device for generating an output signal;
a controller which is arranged to receive the modulating input signal and to generate a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.

It has been found that this can have the effect of reducing distortion effects, particularly when the switching devices are operated close to the limits of their recommended operating range.

Preferably, at least one of the phases has pulses in the output signal substantially aligned with the end of the sampling window. More preferably, pairs of control signals have pulses substantially aligned with different ends of their respective time windows to provide an equalising effect.

In a particularly advantageous arrangement, the phases are arranged such that alternate phases have the pulses in their control signals substantially aligned with different ends of their respective time windows.

The power supply can be used in a wide range of applications. It is particularly well suited to wireless telecommunications base stations where power amplifiers in the transmit chains are required to amplify a signal having a wide bandwidth. This is particularly true in third generation Universal Mobile Telecommunications System (UMTS) base stations. The input modulating signal to the power supply can be an envelope of a signal to be transmitted and the output of the power supply can form the power supply to a power amplifier, so that the power supply tracks the envelope of the input signal.

Further aspects of the invention provide a power amplifier which includes such a modulated power supply, a wireless base station comprising the power amplifier, a control apparatus for a multi-phase pulse width modulated power supply, a method of operating a multi-phase pulse width modulated power supply and a method of generating a power supply signal.

A still further aspect of the invention provides software for implementing a method of controlling operation of a multi-phase pulse width modulated power supply. The software can be stored on a suitable storage medium such as an electronic memory device, hard disk, optical disk or other machine-readable storage medium and will be executed by a suitable processing device on the host device. The software may be delivered on a machine-readable carrier or it may be downloaded directly to the host device via a network connection. It will be appreciated that the software may be installed at any point during the life of the host device.

### BRIEF DESCRIPTION OF THE DRAWINGS

Embodiments of the invention will be described with reference to the accompanying drawings in which:

FIG. 1 shows output signals from a phase of a conventional PWM supply;

FIG. 2 shows operation of a conventional multi-phase PWM supply;

FIG. 3 shows a multi-phase PWM supply;

FIG. 4 shows operation of a multi-phase PWM supply in accordance with an embodiment of the invention;

FIG. 5A shows input and output waveforms of a multi-phase supply in accordance with the invention;

FIGS. 5B and 5C show, by way of contrast, input and output waveforms of a conventional multi-phase supply;

FIG. 6A shows a frequency plot corresponding to the waveform of FIG. 5A;

FIGS. 6B and 6C show, by way of contrast, frequency plots corresponding to the waveforms of FIGS. 5B and 5C;

FIG. 7 shows a modulated PWM supply for use with a power amplifier;

FIG. 8 shows operation of the arrangement of FIG. 7;

FIG. 9 shows a wireless communications system incorporating the arrangement of FIG. 7.

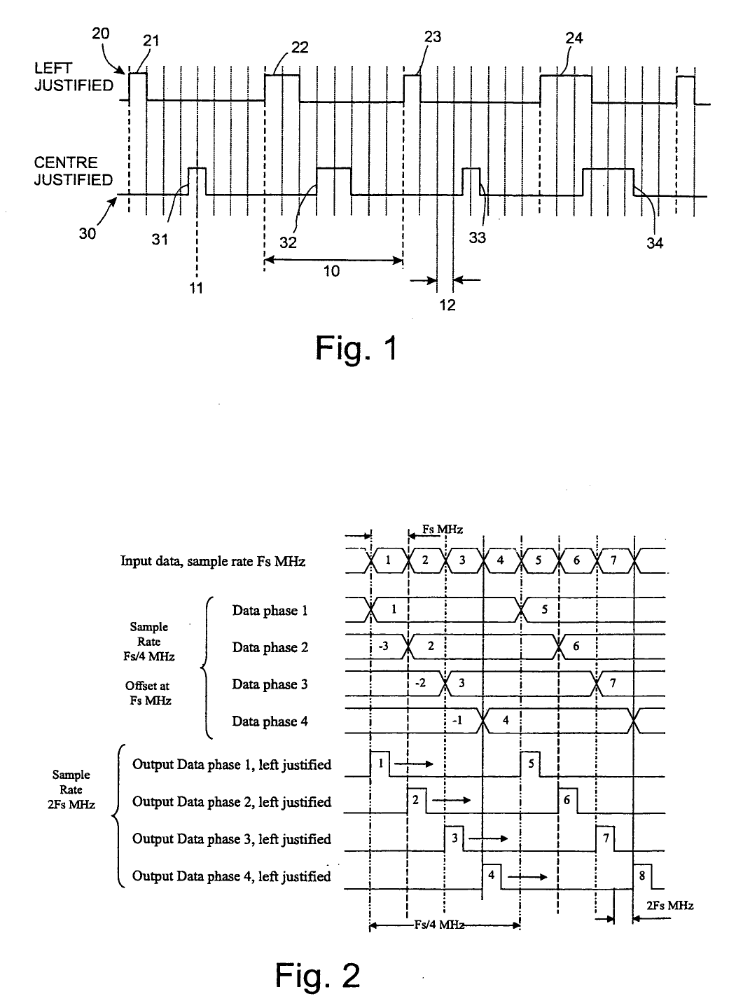

### DESCRIPTION OF PREFERRED EMBODIMENTS

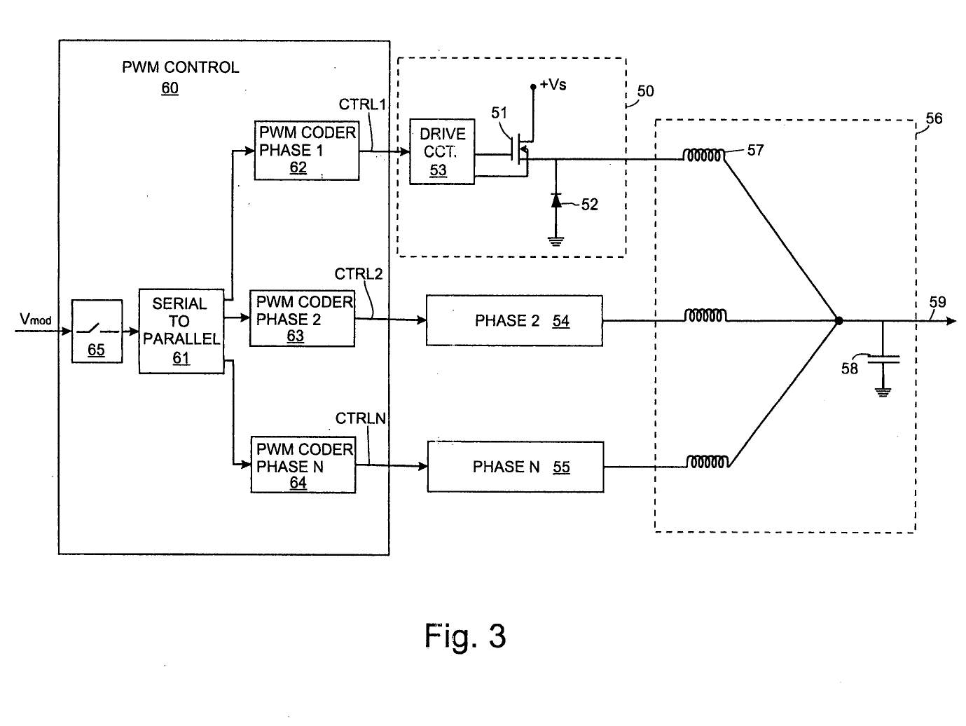

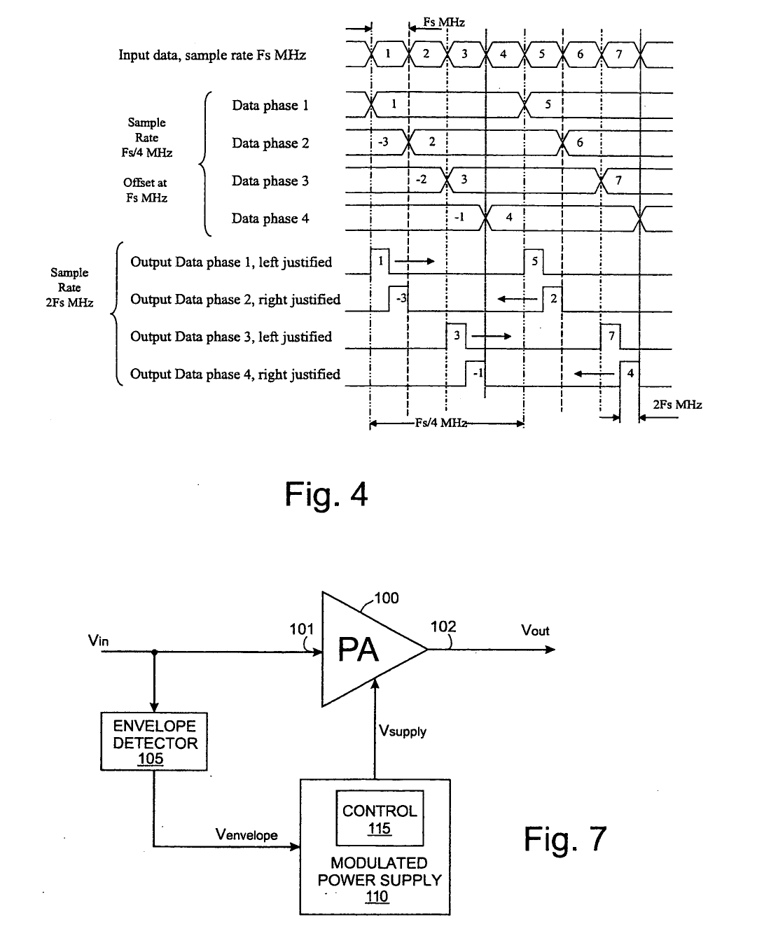

FIG. 3 schematically shows a multi-phase PWM power supply having N phases and FIG. 4 shows a timing diagram of the operation of a four phase supply. For clarity, only one of the phases 50 is shown in detail and other phases 54, 55 have the same form. Phase 1 (50) comprises a power switching device 51, which can be a Field Effect Transistor (FET) or any other suitable switching device. Device 51 is connected between a positive supply rail +Vs and an output and, in use, supplies power when a positive output signal is required. A diode 52 connects between the switching device 51 and ground and provides a bypass path for current when the device is turned off, as is well known. In an alternative form, a phase can have a negative supply rail (−Vs) or two switching devices which are connected in a parallel, ‘totem pole’ arrangement between a positive supply rail +Vs and a negative supply rail −Vs, with diodes placed in parallel with each device and an output being taken from the point between both devices. Each phase also includes a drive circuit 53. The control signal output by coder 62, which is typically implemented as a FPGA, is at a low level which is unsuitable for directly driving the switching device 51. Therefore, drive circuit 53 converts the control signal to a suitable level for driving the switching device 51. Outputs of the N phases are summed and low-pass filtered by an output stage 56 comprising a network of inductors 57 and a capacitor 58. More complex output stages can be implemented than the one shown here, as is well known in the art.

A PWM controller 60 controls operation of the phases 50, 54, 55. Controller 60 receives a modulating input signal Vmod and generates a set of control signals CTRL1, CTRL2, . . . CTRLN for operating the switching devices at appropriate times. Input signal Vmod is sampled 65 at a sampling rate Fs. At each sampling point the sampling unit 65 determines the amplitude of the input modulating signal and assigns the sample a multi-bit digital code. In the same manner as a conventional digital-to-analogue converter, the coding unit has a finite number of discrete values that can be assigned to the sample and the coding unit assigns the code which is closest to the sampled amplitude. Multi-bit samples are conveyed in blocks at a rate of Fs, shown in the top line of FIG. 4 as blocks numbered ‘1’ to ‘7’. A serial to parallel converter 61 divides the incoming sample data into four streams, one for each phase. The data in sample 1 is sent to the coder unit 62 for phase 1, the data in sample 2 is sent to the coder unit 63 for phase 2, and so on. In this example each phase is offset by a time period equal to Fs and each sample is delivered at Fs/4 as there are four phases in total. The blocks numbered ‘−3’, ‘−2’, ‘−1’ are data from earlier samples, which precede the blocks ‘1’ to ‘7’ shown on the top line.

Each coding unit 62, 63, 64 receives a data signal representing a sample value, and assigns a code to the sample value. The output is a pulsed signal (CTRL1, . . . CTRLN) having a width corresponding to the code. The resolution of the output signal is limited, i.e. the width of the pulsed signal can take only one of a limited range of values. In FIG. 4, each of the coding units generates an 8 bit signal, with a resolution of 2 Fs. Preferably, the relationship between the input signal (sample data) and code value (pulse length) is linear although, in some circumstances, a non-linear relationship may be desired. So far, the description of the coding unit has been conventional and will be well understood by a person skilled in the art.

In accordance with the invention, the position of the output pulses from the coding units 62, 63, 64 varies for different phases. Referring to FIG. 4, each coding unit generates a pulsed output signal within a time window, with the time window for a coding unit being offset (in this case by Fs) from those for other phases. For phases 1 and 3, the output pulses generated by the respective coding units are aligned with the left hand side (beginning) of their respective windows. This will be referred to as ‘left justified’, i.e. the pulse, whatever width it has, is aligned so that it's left hand edge is aligned with the start of the window. For phases 2 and 4, the output pulses generated by respective coding units are aligned with the right hand side (end) of the respective windows. This will be referred to as ‘right justified’, i.e. the pulse, whatever width it has, is aligned so that it's right hand edge is aligned with the end of the window. Thus, alternate phases are aligned with different ends of their respective window, the phases progressing ‘left justified, right justified, left justified, right justified’. Other phases can be added in a similar manner, with the same pattern. It has been found that this variation of the pulse alignment, or justification, can help to reduce distortion.

The following table shows the relationship between the digital sample values input to a coding unit and the output signal that is generated by the coding unit for left justified and right justified operation.

| Input to coding | PWM output | PWM output |
|---|---|---|
| unit | (left justified) | (right justified) |
| 0000 | 00000000 | 00000000 |
| 0001 | 10000000 | 00000001 |
| 0010 | 11000000 | 00000011 |
| 0011 | 11100000 | 00000111 |
| 0100 | 11110000 | 00001111 |
| 0101 | 11111000 | 00011111 |
| 0110 | 11111100 | 00111111 |
| 0111 | 11111110 | 01111111 |
| 1000 | 11111111 | 11111111 |

In this example the sample values are 4 bit, there are 4 phases and the resolution of the coding unit is 8 bit. These values have been chosen for ease of implementation, but it will be appreciated that other values could be used. In a practical realisation for a wideband CDMA system, an input signal has a bandwidth of 10 MHz and Fs=80 MHz. An upper limit on the control signal switching rate is dictated by the switching device, which limits the resolution of the control signal. In view of the relatively low resolution, the linearity of the achieved output from the supply is important.

In FIG. 3 the coding units 62, 63, 64 for each phase are shown separately. However, a practical realisation would combine the coding functions for all phases into a single physical unit, such as a FPGA. It will be well understood that the functions of the coding units 62, 63, 64 and controller 60 described above can be implemented by software which is executed by a processor, by hardware such as a FPGA or dedicated integrated circuit, or a combination of these.

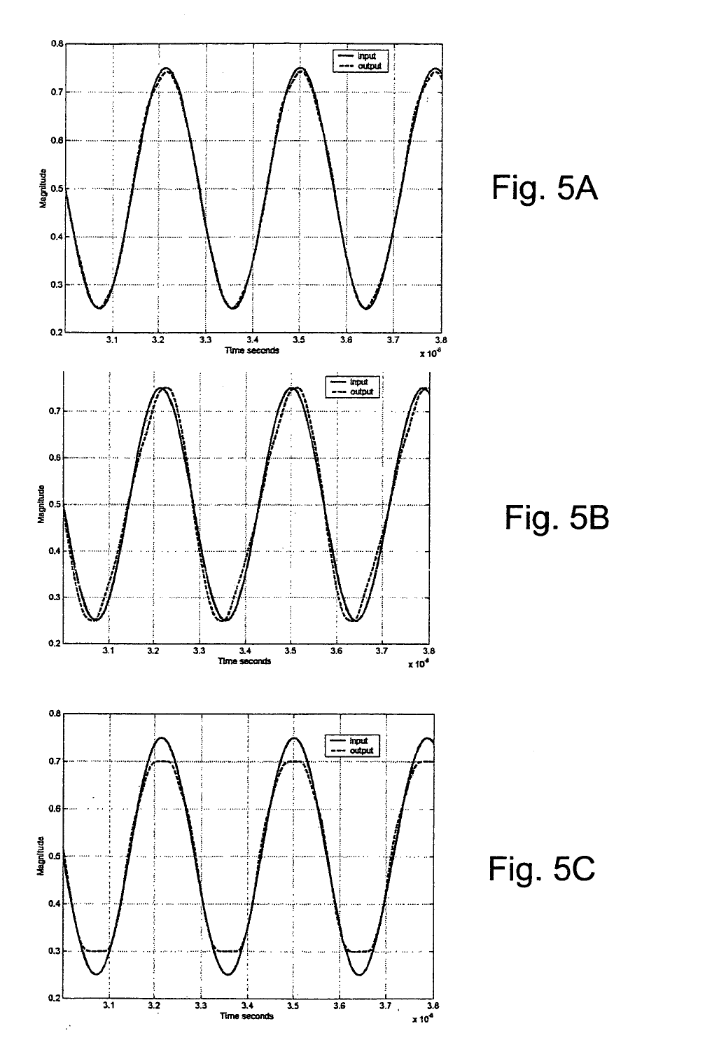

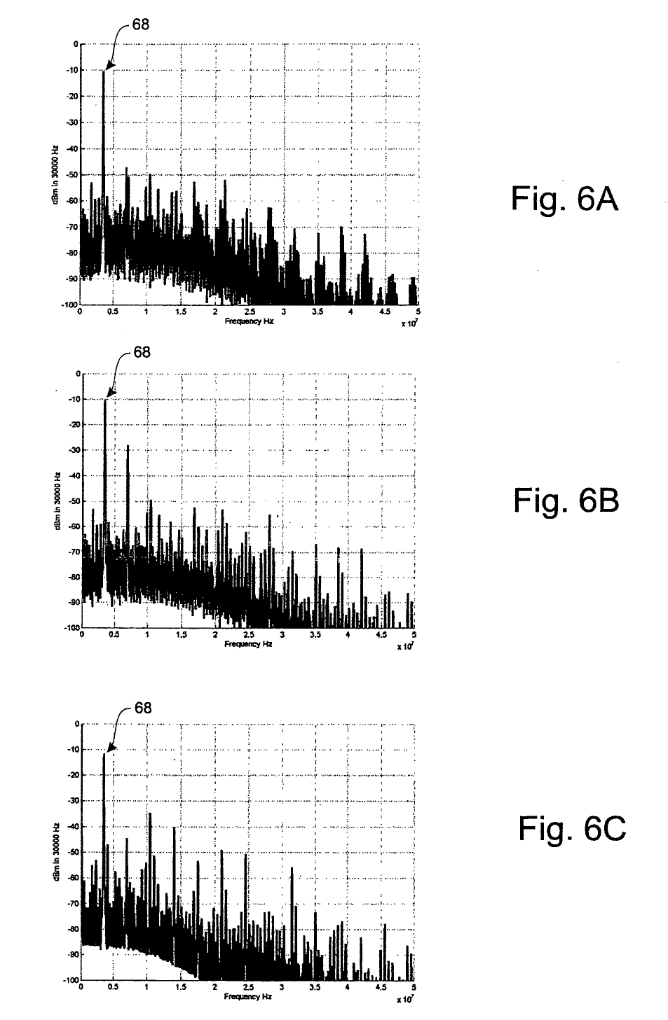

FIGS. 5A and 6A show the results of a simulation of a system in which the coding units operate in the manner just described. FIG. 5A shows the relationship, in the time domain, between a modulating input signal in the form of a 3 MHz sine wave (shown as a solid line) and an output signal (shown as a dashed line) resulting from a multi-phase supply with alternately justified coding units. FIG. 6A shows the output in the frequency domain. In FIG. 6A, the spike numbered 68 represents the fundamental frequency of the sine wave. Other spikes represent noise due to imperfect tracking of the input and output.

By way of contrast, FIGS. 5B, 5C, 6B and 6C show simulations for systems where the coding units operate in a conventional manner. In FIGS. 5B and 6B the coding units are all left justified while in FIGS. 5C and 6C the coding units are all centre justified. It can be seen, from a comparison of the two closely similar traces in time domain of FIG. 5A and the reduced unwanted spikes in FIG. 6A that the linearity of the output to the input is improved in the system in accordance with the invention.

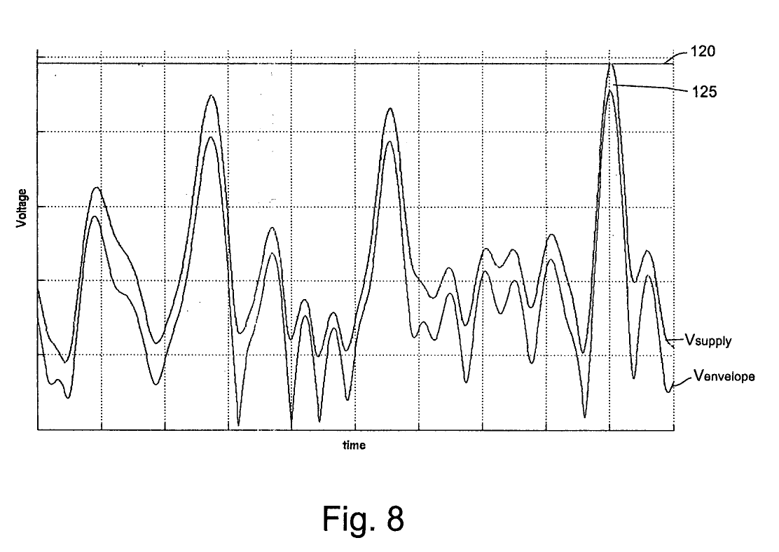

The techniques described herein are applicable to the control of modulated power supplies used in a wide range of applications. One particularly suitable application is a base station of a wireless communications system which processes wideband signals such as CDMA, wideband CDMA (W-CDMA) and Orthogonal Frequency Division Multiplexed (OFDM), as the ratio of signal bandwidth to sampling frequency is particularly low. FIG. 7 shows a power amplifier arrangement comprising a power amplifier 100 and a modulated power supply 110. An input signal Vin which is to be amplified is applied to the input terminal 101 of the power amplifier 100. An input signal, which is to be amplified by the power amplifier 100 is also applied to an envelope detector 105 which outputs a signal Vₑₙᵥₑₗₒₚₑ representing the envelope of the input signal. Vₑₙᵥₑₗₒₚₑ is applied to an input of the modulating power supply 110. A control circuit 115 within the modulating power supply 110 receives the envelope signal and determines appropriate control signals for individual phases, the control signals being justified in the manner previously described. This causes the power supply 110 to generate a supply voltage Vsupply (taken from output 59 in FIG. 3) which substantially tracks the envelope of the input signal Vin. The input signal Vin may also be applied to a pre-distortion module (not shown) before being applied to the input to the power amplifier 100. FIG. 8 shows the operation of the power supply over a period of time, showing the envelope of the input signal Vₑₙᵥₑₗₒₚₑ and the envelope of the dynamically modulated power supply voltage Vsupply. It can be seen that the power supply voltage tracks the signal envelope, including peaks 125. As a comparison, the power supply voltage of a fixed supply is shown by line 120. The power supply 110 and control circuit 115 are of the type previously described.

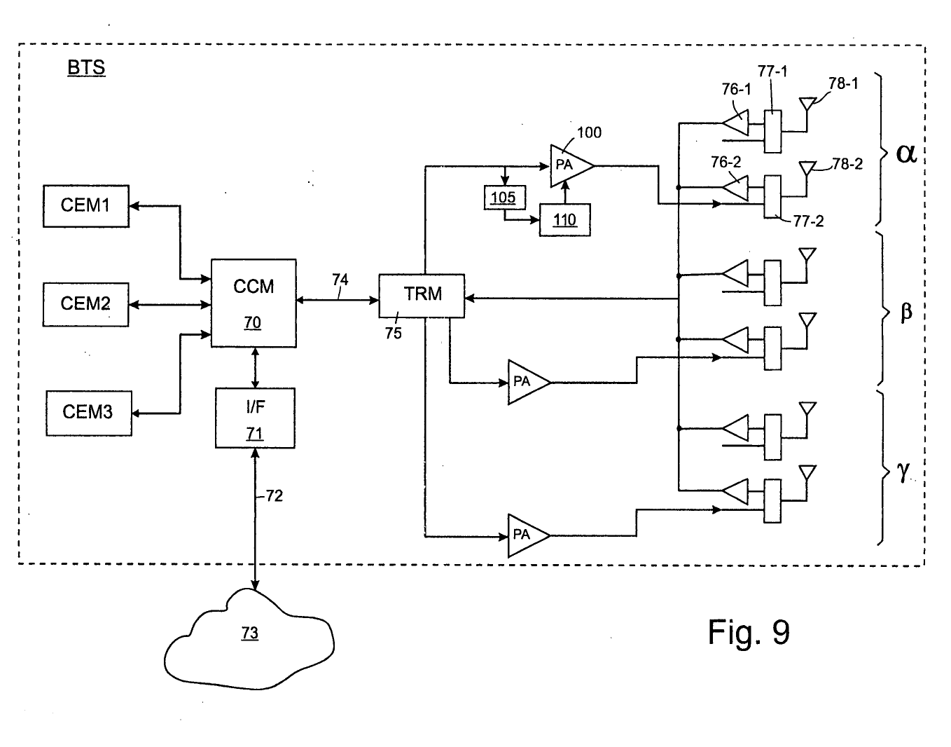

FIG. 9 schematically shows a base station for a wireless communications system, in which the invention can be applied. The baseband section of the base station BTS includes a core switch CCM 70, an interface 71 to the operator's network 73 and a plurality of signal processing units CEM1, CEM2, CEM3. Signals in Packet Data Format including user messages and control signals may be provided on a connection 72 between the network 73 and the BTS, the signals being received at the interface 71 and passed from there to the core switch CCM 70. The core switch 70 is responsible for controlling the complete operation of the transmission and reception of signals to and from the antennas 78 and to and from the signal processing units CEM1, CEM2, CEM3 and the interface 71. The signal processing units undertake baseband signal processing. The core switch CCM 70 is connected 74 to a transceiver unit TRM 75. Transceiver unit TRM 75 performs digital to analog conversion and up-conversion to RF for signals to be transmitted, and performs down-conversion from RF and analog-to-digital conversion on received signals. The arrangement shown has three sectors: α, β and β. In a typical arrangement, different signals will be transmitted in each sector α, β, γ, e.g. in sector α a signal from a transmit unit in TRM 75 is amplified by power amplifier 100, passed through duplexer 77-2 and transmitted from antenna 78-2. Envelope detector 105 receives the signal which is to be transmitted and detects the envelope of it. As previously described, the envelope signal forms a modulating signal for the modulated power supply 110. The modulated power supply has multiple phases with the control signals applied to individual phases being differently justified as previously described. The resulting output from the modulated power supply forms the power supply to the power amplifier 100 such that the power supply tracks the envelope of the signal which is to be transmitted.

The invention is not limited to the embodiments described herein, which may be modified or varied without departing from the scope of the invention.

1. A multi-phase pulse width modulated power supply comprising:
an input for receiving a modulating input signal;
a plurality of phases, each phase comprising a power switching device for generating an output signal;
a controller which is arranged to receive the modulating input signal and to generate a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.

2. A power supply according to claim 1 wherein the at least one control signal has its pulses substantially aligned with a different end of the respective time windows compared to the control signals for other phases.

3. A power supply according to claim 1 wherein substantially half of the control signals have pulses substantially aligned with a different end of their respective time windows compared to the other control signals.

4. A power supply according to claim 3 wherein alternate phases have the pulses in their respective control signals substantially aligned with different ends of their respective time windows.

5. A power supply according to claim 1 wherein pairs of phases have the pulses in their respective control signals substantially aligned with opposite ends of their respective time windows.

6. A power supply according to claim 5 wherein alternate phases have the pulses in their respective control signals substantially aligned with opposite ends of their respective time windows.

7. A power supply according to claim 1 wherein the modulating input signal is an envelope of a signal for processing by a power amplifier and an output of the power supply forms a power supply for the power amplifier.

8. A power amplifier comprising an amplifying device and a modulated power supply according to claim 1, wherein the amplifying device has an input for receiving an input signal for amplification, wherein an envelope level of the input signal is fed to the power supply as the modulating input signal and an output of the power supply forms a power supply for the power amplifier.

9. A wireless base station comprising a power amplifier according to claim 8.

10. A control apparatus for a multi-phase pulse width modulated power supply comprising an input for receiving a modulating input signal and a plurality of phases, each phase comprising a switching device for generating an output signal, wherein the control apparatus is arranged to receive the modulating input signal and to generate a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.

11. A control apparatus according to claim 10 wherein the at least one control signal has its pulses substantially aligned with a different end of the respective time windows compared to the control signals for other phases.

12. A control apparatus according to claim 10 wherein substantially half of the control signals have pulses substantially aligned with a different end of their respective time windows compared to the other control signals.

13. A control apparatus according to claim 12 wherein alternate phases have the pulses in their respective control signals substantially aligned with different ends of their respective time windows.

14. A control apparatus according to claim 10 wherein pairs of phases have the pulses in their respective control signals substantially aligned with different ends of their respective time windows.

15. A control apparatus according to claim 14 wherein alternate phases have the pulses in their respective control signals substantially aligned with different ends of their respective time windows.

16. A method of operating a multi-phase pulse width modulated power supply comprising an input for receiving a modulating input signal and a plurality of phases, each phase comprising a switching device for generating an output signal, the method comprising:
receiving a modulating input signal;
generating a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.

17. A method of generating a power supply signal using a multi-phase pulse width modulated (PWM) power supply which comprises an input for receiving a modulating input signal and a plurality of phases, each phase comprising a switching device for generating a pulse width modulated output signal, the method comprising:
receiving a modulating signal;
generating a set of control signals, each control signal for controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases;
applying the control signals to the switching devices of the phases; and,
combining the outputs of the multiple phases to derive the power supply signal.

18. A power supply signal resulting from the method of claim 17.

19. A computer program product for implementing a method of controlling operation of a multi-phase pulse width modulated power supply comprising an input for receiving a modulating input signal and a plurality of phases, each phase comprising a switching device for generating an output signal, the computer program product comprising instructions which are arranged to cause a control apparatus of the supply to:
receive a modulating input signal; and,
generate a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.

20. A control apparatus for a pulse width modulated power supply comprising an input for receiving a modulating input signal and a switching device for generating an output signal, wherein the control apparatus is arranged to receive the modulating input signal and to generate a control signal for controlling operation of the switching device, wherein the control signal comprises a sequence of time windows, each time window having a pulse of variable width which is substantially aligned with an end of the time window.

21. A pulse width modulated power supply comprising a control apparatus according to claim 18.

22. A method of operating a power supply comprising an input for receiving a modulating input signal and a switching device for generating an output signal, comprising:
receiving the modulating input signal;
generating a control signal for controlling operation of the switching device, wherein the control signal comprises a sequence of time windows, each time window having a pulse of variable width which is substantially aligned with an end of the time window.

23. A multi-phase pulse width modulated power supply comprising:
an input responsive to a modulating input signal;
a plurality of phases, each phase comprising a power switching device;
a controller which is responsive to the modulating input signal and generates a set of control signals, each control signal controlling the operation of the switching device in a respective one of the phases, wherein each control signal comprises a sequence of time windows, there being a pulse of variable width positioned within each time window, and wherein the control signal for at least one of the phases has pulses aligned with a different part of the respective time windows compared to the control signals for other phases.
